(19) United States
(12) Patent Application Publication
(10) Pub. No.: US 2011/0239404 A1
(43) Pub. Date: Oct. 6, 2011

(54) HINGE ASSEMBLY FOR FOLDABLE ELECTRONIC DEVICE

(75) Inventors: CHAO DUAN, Shenzhen City (CN); CHIA-HUA CHEN, Taipei (TW)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/872,119

(22) Filed: Aug. 31, 2010

(30) Foreign Application Priority Data
Mar. 30, 2010 (CN) 201010135999.2

(51) Int. Cl. E05D 11/00; E05F 1/12

(52) U.S. Cl. 16/250

(57) ABSTRACT

A hinge assembly includes a shaft, a follower, a cam, a resilient member and a sleeve. The follower includes a cam surface. The follower is placed around the shaft. The cam has a latching cam surface, the cam surface being engaged with the cam latching surface, the cam placed around the shaft. The resilient member is placed around the shaft and provides an elastic force to make the cam surface abut against the latching cam surface. The sleeve includes a plurality of side portions. Each side portion includes a flattened portion and an arcuate portion arching outside between the flattened portion. The arcuate portion defines an outline of a circle having a larger cross-section than would be allowed only by the flattened portions, and the resilient member is received in the arcuate portions.

### BACKGROUND

1. Technical Field

The present disclosure relates to hinge assemblies and, particularly, to a hinge assembly for foldable electronic devices such as mobile phones, portable computers, and so on.

2. Description of Related Art

At present, perhaps the most popular portable electronic device in the marketplace is the foldable mobile phone, which generally includes a cover section and a body section. The cover section and the body section are rotatably interconnected through a hinge assembly, for switching the telephone between an open position and a closed position.

A typical hinge assembly employs a spring and a sleeve where the flattened surfaces of the sleeve engage with the cover section. However, when the spring is received in the sleeve, the spring outside diameter has to be reduced in size due to the flat surfaces of the sleeve containing the spring. In order to satisfy a predetermined sized spring, the sleeve has to have a large volume. Thus, the volume of hinge assembly is increased, increasing the size of the entire device.

Therefore, there is room for improvement within the art.

### BRIEF DESCRIPTION OF THE DRAWINGS

Many aspects of the present hinge assembly can be better understood with reference to the following drawings. The components in the drawings are not necessarily drawn to scale, the emphasis instead being placed upon clearly illustrating the principles of the present hinge assembly. Moreover, in the drawings, like reference numerals designate corresponding parts throughout the several views.

FIG. 1 is an exploded, isometric view of a hinge assembly.

FIG. 2 is similar to FIG. 1, but shown from another aspect.

FIG. 3 is an enlarged, side view of a sleeve in FIG. 1.

FIG. 4 is an assembled view of the hinge assembly shown in FIG. 1.

FIG. 5 is a schematic view showing a resilient member received in the sleeve.

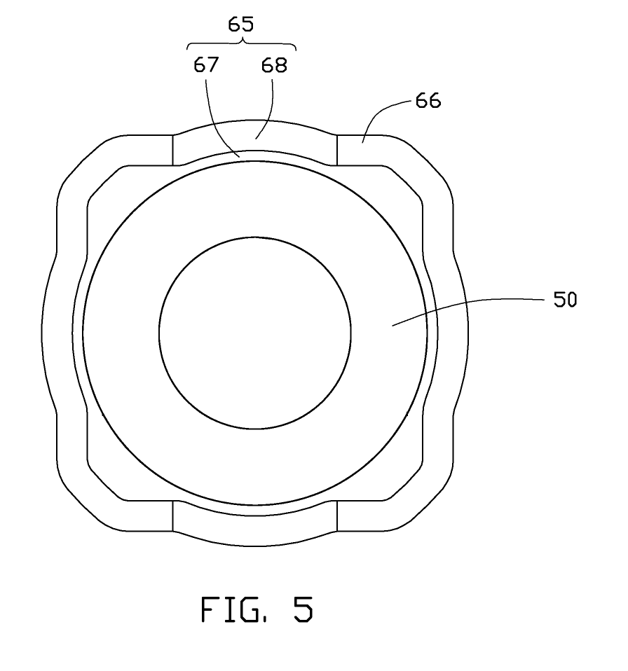

### DETAILED DESCRIPTION

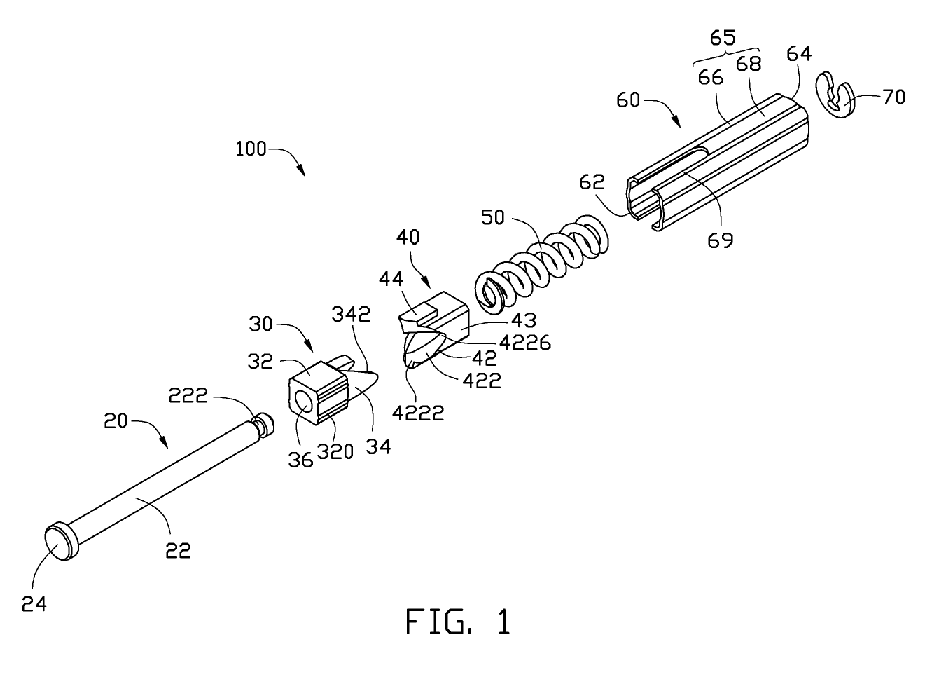

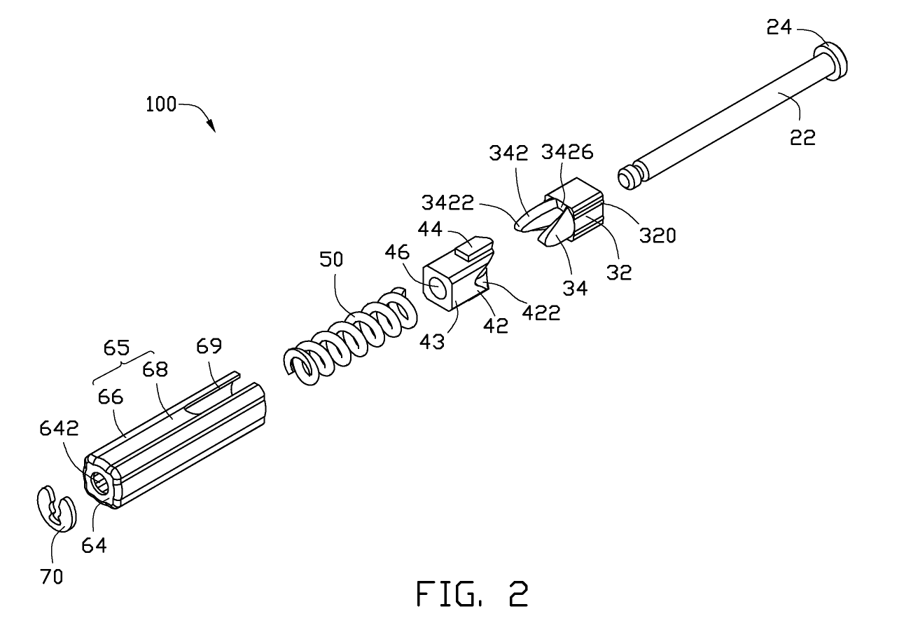

FIGS. 1 and 2 show a hinge assembly 100 according to an exemplary embodiment of the present hinge system. The hinge assembly 100 includes a main shaft 20, a follower 30, a cam 40, a resilient member 50, a sleeve 60, and a tooth-lock washer 70.

The main shaft 20 coaxially includes a shaft portion 22 and a head portion 24. The shaft portion 22 extends from one end of the head portion 24 and has a smaller diameter than the diameter of the head portion 24. A free end of the shaft portion 22 defines a ring groove 222.

The follower 30 includes a fixing portion 32 and a cam portion 34 integrally formed together. The fixing portion 32 is configured for engaging with a body section of a foldable electronic device. In an exemplary embodiment, the fixing portion 32 is substantially cuboid shaped. A plurality of ribs 320 are formed on opposite surfaces of the fixing portion 32. The cam portion 34 is formed at one side of the fixing portion 32. The follower 30 defines a through hole 36. The shaft portion 22 may be received in the through hole 36, and the head portion 24 may abut against the fixing portion 32. The cam portion 34 includes at least one, e.g. two symmetric first cam surfaces 342. Each first cam surface 34 includes a peak 3422 and a valley 3426. The peak 3422 is formed at a highest position of the first cam surface 34. The valley 3426 is formed at a lowest position of the first cam surface 34.

The cam 40 includes a latching cam portion 42 and an end portion 43 extending from the latching cam portion 42. A longitudinal passage 46 is defined in the cam 40 for receiving the shaft portion 22. The latching cam portion 42 includes a second cam surface 422 for engaging with the first cam surfaces 342 of the follower 30. There is one second cam surface 422 for each first cam surface 342. Each second cam surface 422 includes a peak 4222 and a valley 4226. The end portion 43 with the latching cam portion 42 has the same outer profile. At least one, e.g. two protrusions 44 are symmetrically formed on an outer periphery of the end portion 43 for non-rotatably engaging with the sleeve 60.

The resilient member 50 is made of metal and is spiral-shaped (e.g. a coil spring). The resilient member 50 has an inside diameter which is large enough to be placed around the outside diameter of the main shaft 20.

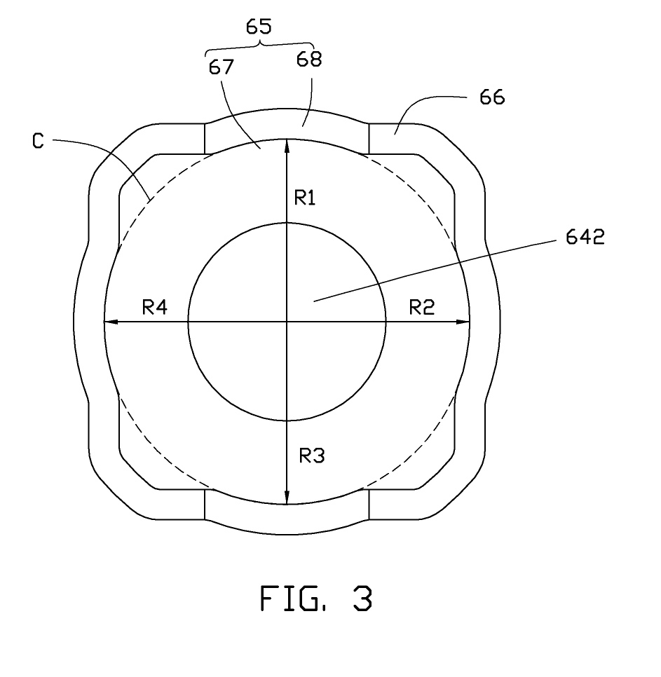

Referring to FIG. 3, the sleeve 60 includes an open end 62 and a partially closed end 64 opposite to each other. The partially closed end 64 has a central hole 642. The sleeve 60 is substantially a hollow polygonal cylinder. In an exemplary embodiment, the sleeve 60 includes four side portions 65 connected to each other for a non-rotatable connection to a cover section of a foldable electronic device. Each side portion 65 includes a flattened portion 66. Arcuate portions 68 are formed between each flattened portion 66. The arcuate portion 68 arches toward the outside of the flattened portion 66. A receiving groove 67 is defined in an inside of the arcuate portion 68 for receiving one part of the resilient member 50. One part of the flattened portions 66 except for the arcuate portions 68 transmits torsion moment to the cover section of the foldable electronic device. In this exemplary embodiment, the sleeve 60 is formed by a punch press process. The radius all the arcuate portions are the same (R1=R2=R3=R4). Therefore, the arcuate portions 68 substantially form the outline of a circle C. Circle C has a diameter greater than it would have compared to the cross section of a sleeve with only flat surfaces. The resilient member 50 may be completely received in the arcuate portions 68. Each of two opposite side portion 65 defines a cutout 69 for receiving the protrusions 44 of the cam 40. In this exemplary embodiment, the cutout 69 is defined in each arcuate portion 68, and extends from the open end 62 partially down the length of the sleeve 60. Understandably, the sleeve 60 may be more than a four-sided polygonal cylinder. The number of arcuate portions 68 corresponds to the number of planar surfaces of the polygonal sleeve 60.

The washer 70 is made of a strong material, such as metal. In the present embodiment, the washer 70 is substantially C-shaped and is clasped in the ring groove 222, thereby mating with the main shaft 20.

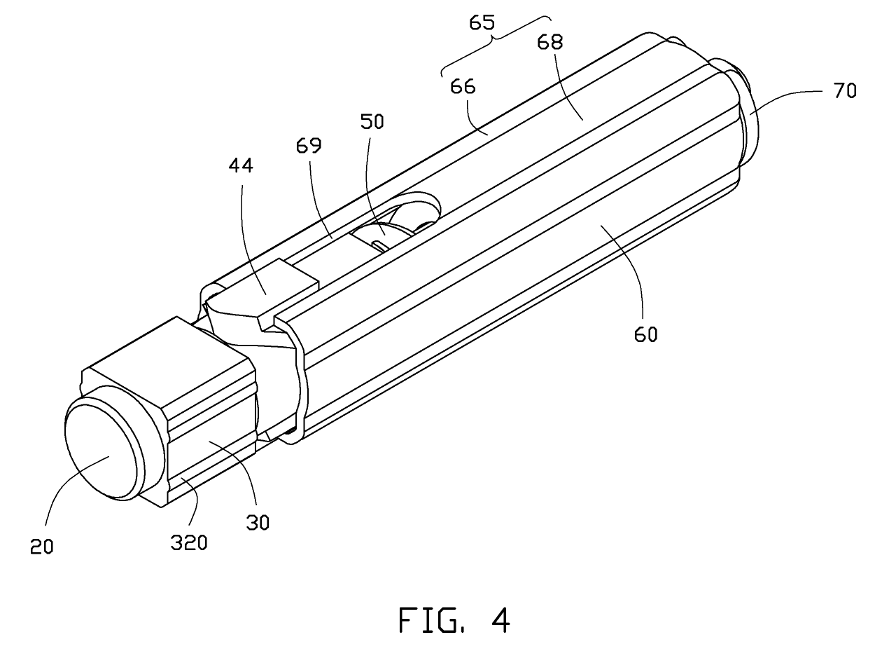

Referring to FIG. 4, the shaft portion 22 of the main shaft 20 extends through the through hole 36 of the follower 30, the passage 46 of the cam 40 and the resilient member 50. The head portion 24 abuts against the fixing portion 32. The second cam surface 422 of the cam 40 engages with the first cam surface 342 of the follower 30. Next, the main shaft 20 including the above elements is received in the sleeve 60 from the open end 62. The resilient member 50 engages the receiving grooves 67 of the arcuate portions 68. One free end of the main shaft 20 passes through the central hole 642 of the partially closed end 64, and the washer 70 is mounted in the ring groove 222. One end of the resilient member 50 abuts against the partially closed end 64, and the opposite end of the resilient member 50 abuts against the cam 40. The protrusions 44 are received in the cutouts 69. Thus, the hinge assembly 100 is integrated into a complete unit.

The hinge assembly 100 is used to interconnect a body section and a cover section of the foldable electronic device. The follower 30 non-rotatably engages the main body, and the sleeve 60 non-rotatably engages with the cover.

When the cover section is closed relative to the main section, the peaks 4222 of the second cam surface 422 abut against the first cam surface 342. The resilient member 50 is compressed to enable the cover and the main body to remain in a closed and stable state.

To open the foldable electronic device, the cover section is manually rotated away from the body section, hence the sleeve 60 and the cam 40 rotate relative to the follower 30. The peaks 4222 of the second cam surface 422 slide along the first cam surface 342, and the resilient member 50 is compressed further. When the cover section is opened to a predetermined angle, the peaks 4222 slide over the peaks 3422 of the first cam surfaces 342. At the same time, the resilient member 50 is almost completely compressed. Then, when the cover is released, the cam 40 automatically rotates relative to the follower 40 due to the expansion of the resilient member 50 as the peaks 3422 slide down along the second cam surface 42. Thus, the cover section is automatically rotated to a fully and stable open state. The process of closing the cover is reverse to the process of opening the cover. Since the flattened portions 66 of the sleeve 60 include arcuate portions 68, thus the sleeve 60 may provide a larger space to receive the resilient member 50 without adding to the overall bulk of the hinge assembly 100.

It should be understood that the cam portions of follower 30 and the cam 40 may have other shapes. The shape of the cam portion may be changed according to the desired open angle of the cover. The washer 70 may be soldered to the shaft 20. The head portion 24 may be integrally attached with the main shaft 20.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A sleeve for a hinge assembly, the sleeve comprising a plurality of side portions, each side portion including a flattened portion and an arcuate portion arching outside from between the flattened portion, all the arcuate portions substantially defining an outline of a circle having a larger cross-section than would be allowed only by the flattened portions.

2. The sleeve as claimed in claim 1, wherein each arcuate portion defines a cutout extending from the open end partially down the length of the sleeve.

3. The sleeve as claimed in claim 1, wherein an inside wall of each arcuate portion defines a receiving groove.

4. The sleeve as claimed in claim 1, wherein the sleeve including four side portions, and the number of the arcuate portion is four.

5. A hinge assembly comprising:
a shaft;
a follower including a cam surface, the follower placed around the shaft;
a cam having a latching cam surface, the cam surface being engaged with the cam latching surface, the cam placed around the shaft;
a resilient member being placed around the shaft and providing an elastic force to make the cam surface abut against the latching cam surface;
a sleeve comprising a plurality of side portions, each side portion including a flattened portion and an arcuate portion arching outside from between the flattened portion, all of the arcuate portion substantially defining an outline of a circle having a larger cross-section than would be allowed only by the flattened portions, and the resilient member being received in the arcuate portions.

6. The hinge assembly as claimed in claim 1, wherein an inside wall of each arcuate portion defines a receiving groove, and the resilient member is received in the arcuate portions.

7. The hinge assembly as claimed in claim 5, wherein the sleeve includes an open end and a partially closed end, and the arcuate portions extend from the partially end to one part of the sleeve.

8. The hinge assembly as claimed in claim 5, wherein the sleeve including four side portions, and the number of the arcuate portion is four.
